(19) United States
(12) Patent Application Publication
(10) Pub. No.: US 2024/0373294 A1
(43) Pub. Date: Nov. 7, 2024

(54) METHOD AND RELATED NETWORK CIRCUIT FOR IMPROVING LATENCY OF WIRELESS NETWORK

(71) Applicant: MEDIATEK Inc., Hsinchu City (TW)

(72) Inventors: Ying-You LIN, Hsinchu City (TW); Kuo-Wei CHEN, Hsinchu City (TW); Chiao-Chih CHANG, Hsinchu City (TW); Chia-Hsiang CHANG, Hsinchu City (TW)

(21) Appl. No.: 18/650,380

(22) Filed: Apr. 30, 2024

Related U.S. Application Data
(60) Provisional application No. 63/500,064, filed on May 4, 2023.

(51) Int. Cl. H04W 28/24; H04W 74/0816; H04W 84/12

(52) U.S. Cl. CPC H04W 28/24; H04W 74/0816; H04W 84/12

(57) ABSTRACT

The invention provides a method and related network circuit for improving latency of a wireless network (e.g., a Wi-Fi network). The method may be executed by a device (e.g., a Wi-Fi station) of the wireless network, and may comprise: configuring a duration threshold according to a latency requirement, and, when transmitting a physical layer protocol data unit (PPDU) over the wireless network, causing the PPDU not to be longer than the duration threshold. In an embodiment, the latency requirement may be obtained by handshaking with one or more other devices of the wireless network.

This application claims the benefit of U.S. provisional application Ser. No. 63/500,064, filed May 4, 2024, the subject matter of which is incorporated herein by reference.

### FIELD OF THE INVENTION

The invention relates to a method and related network circuit for improving latency of a wireless network, and more particularly, to a method and related network circuit which may cause a physical layer protocol data unit (PPDU) not to be longer than a duration threshold when a device of the wireless network transmits the PPDU over the wireless network, wherein the duration threshold may be configured according to a latency requirement obtained by handshaking with one or more other devices of the wireless network.

### BACKGROUND OF THE INVENTION

Functionality for communicating over a wireless network is essential for modern electronics.

### SUMMARY OF THE INVENTION

An object of the invention is providing a method (e.g., 300 in FIG. 3) for improving latency of a wireless network (e.g., 100 in FIG. 1); the method may be executed by a device (e.g., one of sta[0] to sta[N] in FIG. 1) of the wireless network, and the method may comprise: configuring (e.g., 306 in FIG. 3) a duration threshold (e.g., T0 in FIG. 3) according to a latency requirement, and causing (e.g., 308 in FIG. 3) a physical layer protocol data unit (PPDU, e.g., one of D[1] to D[K] and U[1] to U[P] in FIG. 4) not to be longer than the duration threshold when transmitting the PPDU over the wireless network.

In an embodiment (e.g., FIG. 3), the latency requirement may be obtained by handshaking with one or more other devices of the wireless network. In an embodiment (e.g., FIG. 3), the latency requirement may be received from one or more other devices of the wireless network.

In an embodiment (e.g., FIG. 3), the latency requirement may include a tolerable latency; when the device configures the duration threshold according to the latency requirement, the device may cause the duration threshold not to be longer than the tolerable latency.

In an embodiment (e.g., FIG. 3), the tolerable latency may be shorter than a parameter aPPDUMaxTime specified in IEEE 802.11, with IEEE being an abbreviation of institute of electrical and electronics engineers.

In an embodiment (e.g., FIG. 1), the device (e.g., sta[0] in FIG. 1) may be a Wi-Fi access point (AP) or hot spot.

In an embodiment (e.g., FIG. 5a, 7a, 7b or 8), the PPDU (e.g., D[k] in FIG. 5a, or U[p] in FIG. 7a, 7b or 8) may be followed by a follow-up frame (e.g., d[k] in FIG. 5a, or u[p] in FIG. 7a, 7b or 8) transmitted after an interframe space (e.g., ia1[k] in FIG. 5a, or ib2[p] in FIG. 7a, 7b or 8) elapses; when the device causes the PPDU not to be longer than the duration threshold, the device may cause a reference duration (e.g., Ta3[k] in FIG. 5a, or Tc3[p] in FIG. 7a or 7b) related to the PPDU not to be longer than the duration threshold, wherein the reference duration may be a sum of a duration of the PPDU, the interframe space and a duration of the follow-up frame.

In an embodiment (e.g., FIG. 6c), when the device (e.g., sta[0] in FIG. 1) transmits the PPDU (e.g., D[k] in FIG. 6c), the device may transmit the PPDU using a first resource unit, and may cause another device (e.g., one of sta[1] to sta[N] in FIG. 1) of the wireless network to transmit using a second resource unit during the PPDU (e.g., during Ta0[k] in FIG. 6c).

In an embodiment (e.g., FIG. 4), the device (e.g., sta[0] in FIG. 1) may transmit the PPDU (one of D[1] to D[K] in FIG. 4) during a transmission opportunity (e.g., 400 in FIG. 4), and the method may further comprise: causing another device (e.g., one of sta[1] to sta[N] in FIG. 1) of the wireless network to transmit a second PPDU (e.g., one of U[1] to U[P]) during the transmission opportunity, and causing said another device to cause the second PPDU not to be longer than the duration threshold when said another device transmits the second PPDU.

In an embodiment (e.g., one of FIG. 7a to FIG. 7d and FIG. 8), the device may be a non-AP station.

In an embodiment (e.g., FIG. 7a, 7c or 8), the device (e.g., sta[nu[p,q]] in FIG. 7a or 7c, or one of sta[nu1[p,w]] and sta[nu2[p,w]] in FIG. 8) may transmit the PPDU (e.g., U0[p,q] in FIG. 7a or 7c, or one of U1[p,w] and U2[p,w] in FIG. 8) after a preceding frame (e.g., TG[p] in FIG. 7a, 7c or 8) is transmitted and an interframe space (e.g., ib1[p] in FIG. 7a, 7c or 8) elapses; when the device causes the PPDU not to be longer than the duration threshold, the device may cause a reference duration (e.g., Tc9[p] in FIG. 7a or 7c) not to be longer than the duration threshold, wherein the reference duration may be a sum of a duration of the preceding frame, the interframe space and a duration of the PPDU.

In an embodiment (e.g., FIG. 7a or 8), the device (e.g., sta[nu[p, q]] in FIG. 7a, or one of sta[nu1[p,w]] and sta[nu2[p,w]] in FIG. 8) may transmit the PPDU (e.g., U0[p,q] in FIG. 7a, or one of U1[p,w] and U2[p,w] in FIG. 8) after a preceding frame (e.g., TG[p] in FIG. 7a or 8) is transmitted and a first interframe space (e.g., ib1[p] in FIG. 7a or 8) elapses, and the PPDU may be followed by a follow-up frame (e.g., u[p] in FIG. 7a or 8) transmitted after a second interframe space (e.g., ib2[p] in FIG. 7a or 8) elapses; when the device causes the PPDU not to be longer than the duration threshold, the device may cause a reference duration (e.g., Tc11[p] in FIG. 7a) not to be longer than the duration threshold, wherein the reference duration may be a sum of a duration of the preceding frame, the first interframe space, a duration of the PPDU, the second interframe space and a duration of the follow-up frame.

In an embodiment (e.g., FIG. 3), the method may further comprise: determining (e.g., 304 in FIG. 3) whether to enable a latency improvement before causing (e.g., 308 in FIG. 3) the PPDU not to be longer than the duration threshold, wherein causing the PPDU not to be longer than the duration threshold may be executed if the latency improvement is enabled.

In an embodiment (e.g., FIG. 3), the method may further comprise: not restricting (e.g., 312) a duration of the PPDU according to the duration threshold if the latency improvement is not enabled.

In an embodiment (e.g., FIG. 3), when the device transmits the PPDU, the device may transmit the PPDU via a dedicated link which is initialized after determining (e.g., 304 in FIG. 3) to enable the latency improvement.

In an embodiment (e.g., FIG. 3), when the device transmits the PPDU, the device may transmit the PPDU via an existed link which exists before determining (e.g., 304 in FIG. 3) whether to enable the latency improvement.

An object of the invention is providing a network circuit (e.g., NC[n] in FIG. 2) for a device (e.g., sta[n]) of a wireless network (e.g., 100 in FIG. 1); the network circuit may comprise a physical layer (PHY) circuit (e.g., phy[n] in FIG. 2) and a medium access control (MAC) circuit (e.g., mac[n] in FIG. 2). The PHY circuit may be arranged to transmit a physical layer protocol data unit (PPDU) over the wireless network. The MAC circuit may be coupled to the PHY circuit, may be arranged to cause the PPDU not to be longer than a duration threshold (e.g., T0 in FIG. 3) if a latency improvement is enabled, and may be arranged not to restrict a duration of the PPDU by the duration threshold if the latency improvement is not enabled.

In an embodiment, the duration threshold may be configured according to a latency requirement received from another device of the wireless network.

In an embodiment (e.g., FIG. 5a, 7a, 7b or 8), the PPDU (e.g., D[k] in FIG. 5a, or U[p] in FIG. 7a, 7b or 8) may be followed by a follow-up frame (e.g., d[k] in FIG. 5a, or u[p] in FIG. 7a, 7b or 8) transmitted after an interframe space (e.g., ia1[k] in FIG. 5a, or ib2[p] in FIG. 7a, 7b or 8) elapses. When the MAC circuit causes the PPDU not to be longer than the duration threshold, the MAC circuit may be arranged to cause a reference duration (e.g., Ta3[k] in FIG. 5a, or Tc3[p] in FIG. 7a or 7b) related to the PPDU not to be longer than the duration threshold, wherein the reference duration may be a sum of a duration of the PPDU, the interframe space and a duration of the follow-up frame.

In an embodiment (e.g., FIG. 7a, 7c or 8), the PHY circuit may be further arranged to transmit the PPDU (e.g., U0[p,q] in FIG. 7a or 7c, or one of U1[p,w] and U2[p,w] in FIG. 8) after the PHY circuit receives a preceding frame (e.g., TG[p] in FIG. 7a, 7c or 8) and an interframe space (e.g., ib1[p] in FIG. 7a, 7c or 8) elapses, and the MAC circuit may be arranged to cause a reference duration (e.g., Tc9[p] in FIG. 7a or 7c), which may be a sum of a duration of the preceding frame, the interframe space and a duration of the PPDU, not to be longer than the duration threshold.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a concise schematic diagram showing an example of a wireless network according to an embodiment of the invention, wherein the wireless network may comprise two or more devices;

FIG. 2 is a concise schematic diagram depicting a device of the wireless network according to an embodiment of the invention;

FIG. 3 depicts a flowchart according to an embodiment of the invention;

FIG. 4 depicts a series of sections during a transmission opportunity (TXOP) according to an embodiment of the invention;

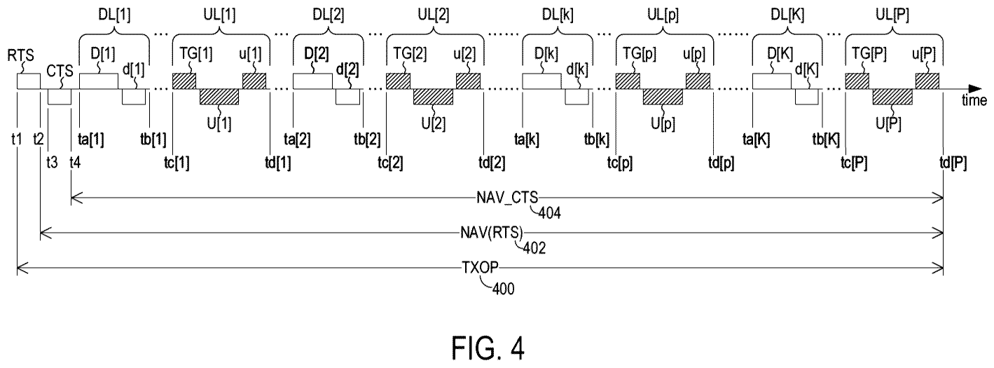

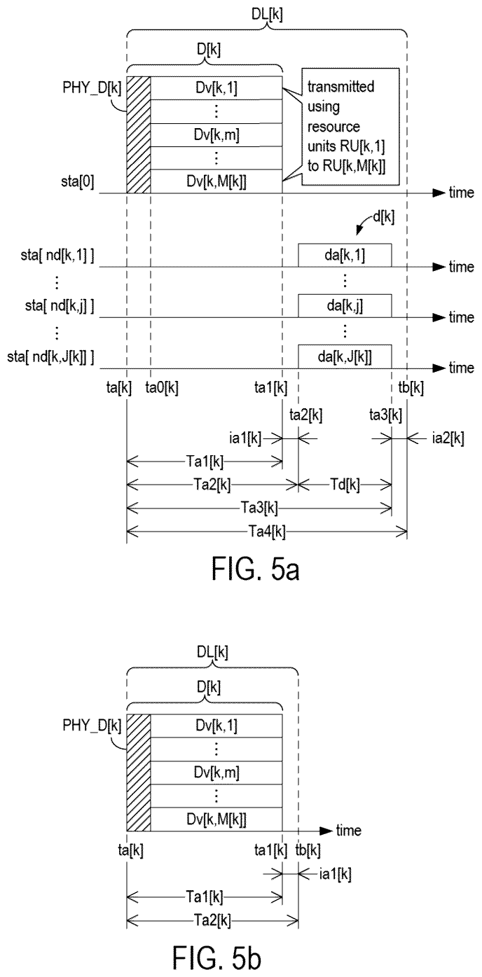

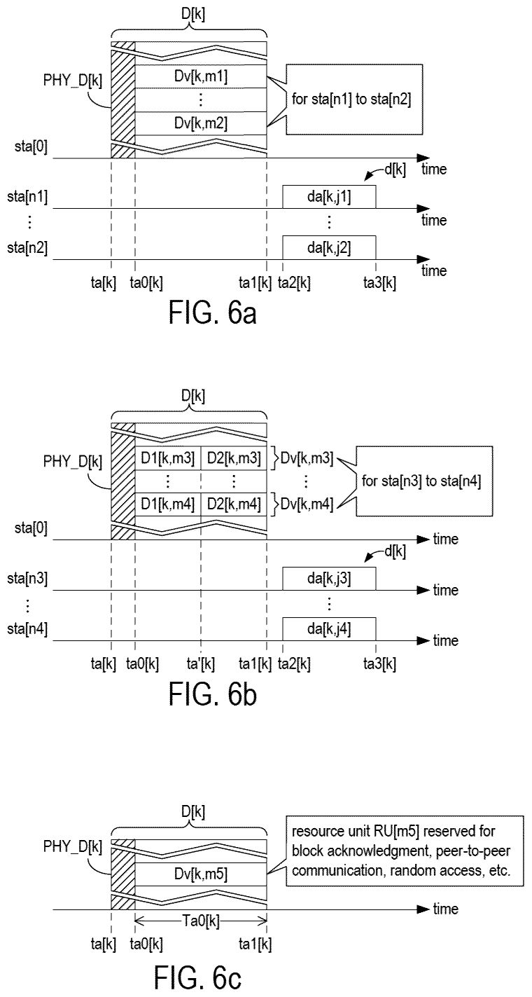

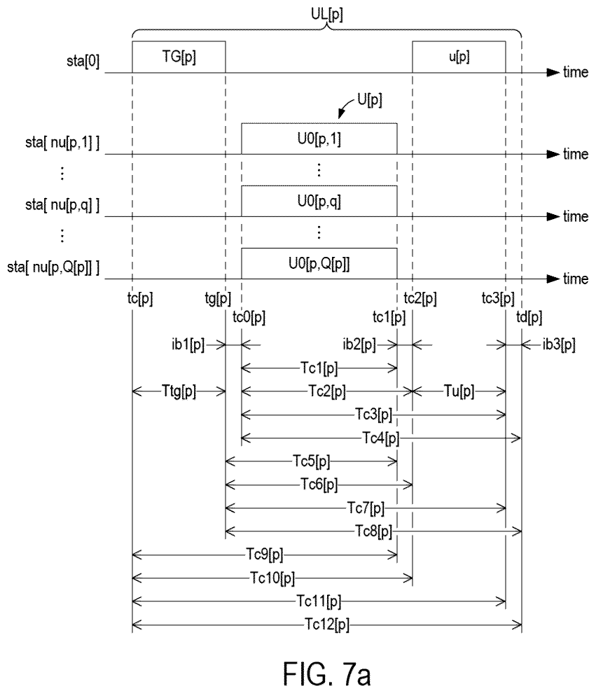

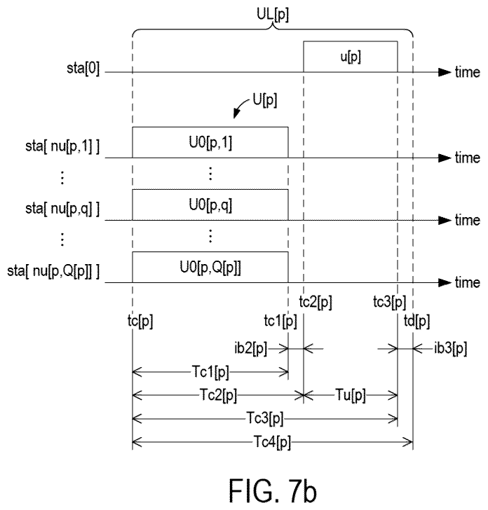

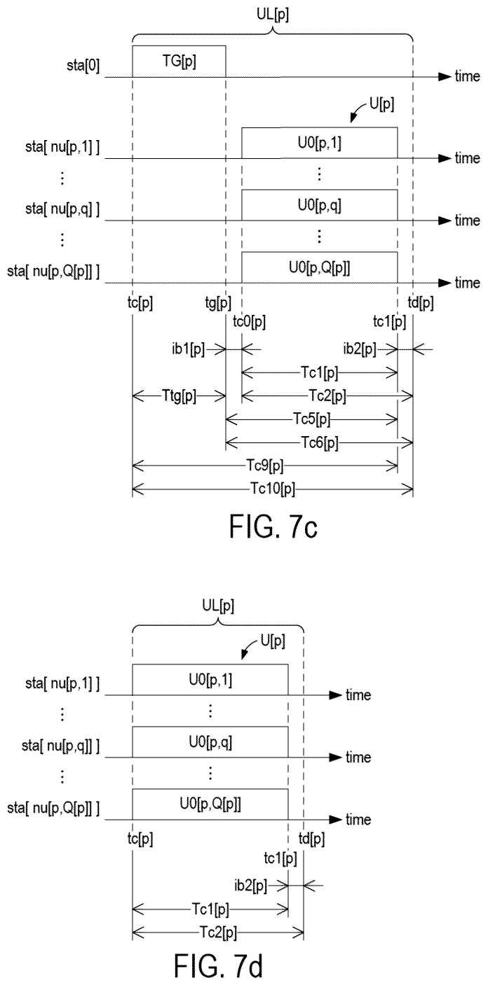

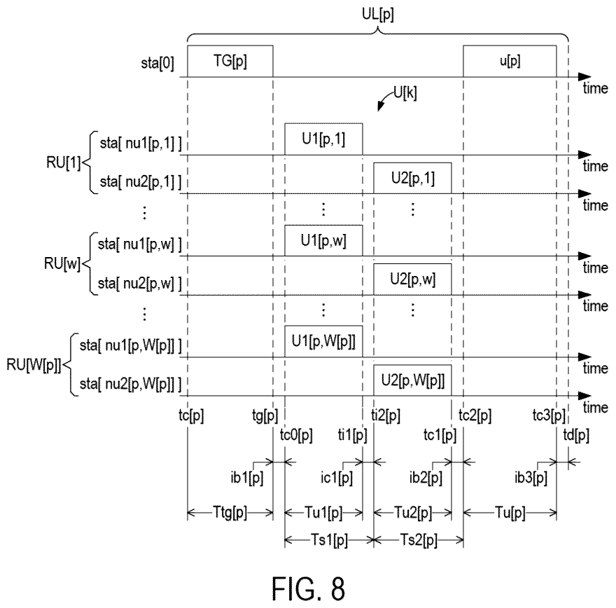

each of FIG. 5a and FIG. 5b depicts, according to an embodiment of the invention, an example of one of the sections shown in FIG. 4, wherein the section may cover a PPDU;

each of FIG. 6a to FIG. 6c depicts, according to an embodiment of the invention, a usage example of the PPDU shown in FIG. 5a or 5b; and

each of FIG. 7a to FIG. 7d and FIG. 8 depicts, according to an embodiment of the invention, an example of one of the sections shown in FIG. 4.

### DETAILED DESCRIPTION OF PREFERRED EMBODIMENTS

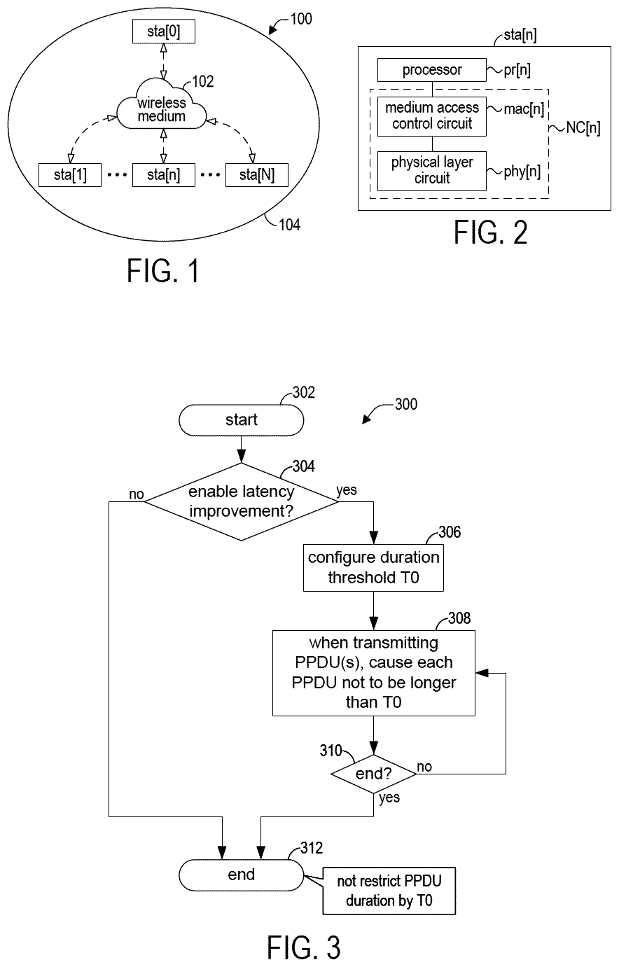

FIG. 1 depicts a diagram of a wireless network 100 according to an embodiment of the invention. In an embodiment, the wireless network 100 may be a Wi-Fi network which may operate based on existed wireless communication standard(s) developed by LAN/MAN standards committee of IEEE and/or adopted by Wi-Fi Alliance, including IEEE Std 802.11-2020 and subsequent amendment(s) such as IEEE Std 802.11ax-2021 and drafting IEEE Std 802.11be, etc.; wherein LAN is an abbreviation of Local Area Networks, MAN is an abbreviation of Metropolitan Area Networks, and IEEE is an abbreviation of Institute of Electrical and Electronics Engineers. The existed wireless communication standard(s) mentioned above will be referred to as the legacy Wi-Fi hereinafter.

The wireless network 100 may comprise two or more devices such as sta[0], sta[1] to sta[N], wherein the index N may be an integer greater than or equal to one. Each device sta[n] (for n=0 to N) may transmit and/or receive frames by electromagnetic waves propagating through a wireless medium 102, the devices sta[0] to sta[N] may therefore mutually interact and/or communicate; each said frame may be a control frame, a management frame or a data frame formatted as a physical layer protocol data unit (PPDU) specified in the legacy Wi-Fi.

In the wireless network 100, each of the devices sta[0] to sta[N] may function as a station specified in the legacy Wi-Fi. The devices sta[0] to sta[N] may form a service set 104 specified in the legacy Wi-Fi; for example, the service set 104 may be a basic service set (BSS), an independent BSS (IBSS), a personal BSS (PBSS), an infrastructure BSS, a mesh BSS (MBSS) or a portion of an extended service set (ESS), etc. In an embodiment, one or more of the devices sta[0] to sta[N] may have additional functions to work as an access point (AP) specified in the legacy Wi-Fi. A device which works as an access point may be referred to an AP device, while a device which simply functions as a station and does not work as an access point may be referred to as a non-AP device. For concise disclosure of the invention, it is assumed hereinafter that the device sta[0] is an AP device, and each of the remaining devices sta[1] to sta[N] is a non-AP device which does not work as an access point. However, besides the AP device sta[0], the non-AP devices sta[1] to sta[N] and the service set 104, the network 100 may comprise one or more other service sets, one or more other AP devices and/or one or more other non-AP devices, though not depicted for conciseness.

Each of the devices sta[0] to sta[N] may be a consumer electronic product or a home electronic product, such as a mobile phone, a smart phone, a tablet computer, a notebook computer, a desktop computer, a network attached storage (NAS), a video game console, a portable game console, a wearable gadget (e.g., a smart watch), an earphone, a headset for virtual reality, augmented reality, mixed reality, cross reality and/or extended reality, a digital camera, a digital camcorder, a surveillant camera, a security sensor, a drone, a monitor, a television, a projector, a speaker, an air conditioner, a smart washing machine, a smart refrigerator, an air purifier, or a robot cleaner, etc. In addition, each of the device sta[0] to sta[N] may be a smart office equipment (e.g., a photocopier, a printer, a conference camera, a conference microphone, a conference speaker, etc.), a telematics device, an Internet-Of-Things (IOT) device, a smart vehicle (e.g., a smart car, etc.), or an industrial machine (e.g., an industrial robot), etc. The AP device sta[0] may be a router, a customer premise equipment (CPE) or a mobile phone working as a hotspot, etc., and may bridge between the wireless network 100 and one or more other network(s) (not shown), such as a wired network and/or a wireless mobile telecommunication network specified by, e.g., the third generation partnership project (3GPP).

FIG. 2 depicts a concise and conceptual schematic diagram of each device sta[n] (for n=1 to N) of the devices sta[0] to sta[N] (FIG. 1) according to an embodiment of the invention. The device sta[n] may comprise a processor pr[n] and a network circuit NC[n] coupled to the processor pr[n]. The processor pr[n] may direct operations of the device sta[n]. The network circuit NC[n] may be coupled to the processor pr[n], and may comprise a medium access control (MAC) circuit mac[n] and a physical layer (PHY) circuit phy[n]. The MAC circuit mac[n] may be coupled between the processor pr[n] and the PHY circuit phy[n], and may implement medium access control for the device sta[n] as specified in the legacy Wi-Fi; for example, the medium access control circuit mac[n] may control access of the wireless medium 102 according to the legacy Wi-Fi. The PHY circuit phy[n] may implement physical layer for the device sta[n] as specified in the legacy Wi-Fi; for example, the PHY circuit phy[n] may transmit and/or receive electromagnetic waves which may propagate at frequency band(s) specified in the legacy Wi-Fi, and may carry frames coded and modulated according to coding and modulation scheme(s) specified in the legacy Wi-Fi. It is noted that each device sta[n] may comprise other circuit(s) and/or hardware not depicted in FIG. 2 for conciseness, such as a display module, a user interface (e.g., touch panel and/or keyboard), a memory, a data storage, and/or another set of medium access circuit and physical layer circuit for another network not depicted.

According to the legacy Wi-Fi, a maximum duration of a physical layer protocol data unit (PPDU), known as a parameter aPPDUMaxTime specified in the legacy Wi-Fi, may be 5.484 milliseconds (ms). However, spending such a long time on a PPDU will cause a latency too long to be tolerated by devices running applications which demand low latency. For example, a device running application(s) involving virtual reality, augmented reality, cross reality and/or extended reality may need frequent data exchange over a wireless network, and may therefore require ultra-low latency, such as a latency shorter than 2 ms with a 99.99 percentage rate of no package loss.

To address the long latency issue of the legacy Wi-Fi, the MAC circuit mac[n] and the PHY circuit phy[n] of each device sta[n] may not only implement conventional functionality specified in the legacy Wi-Fi, but may also implement a latency improvement according to the invention. The latency improvement will be described below by referring to FIG. 3.

FIG. 3 depicts a flowchart 300 according to an embodiment of the invention. The devices sta[0] to sta[N] of the wireless network 100 (FIG. 1) may coordinate execution of the flowchart 300 to implement the latency improvement of the invention, and may therefore improve latency of the wireless network 100 (FIG. 1) to overcome the long latency issue of the legacy Wi-Fi. The flowchart 300 may comprise steps described as follows.

Step 302: the flowchart 300 may start. In an embodiment, when one of the devices sta[1] to sta[N], assuming to be the device sta[1] hereinafter for concise understanding of the invention, requires low latency (e.g., starts an application demanding low latency), the device sta[1] may inform the AP device sta[0] to request enabling of the latency improvement; in response, the AP device sta[0] may start the flowchart 300 at step 302, and may proceed to step 304.

For example, in an embodiment, the MAC circuit mac[1] (FIG. 2 with n=1) of the requester device sta[1] may embed a request to enable the latency improvement in an action frame (not depicted) specified in the legacy Wi-Fi, and the PHY circuit phy[1] of the device sta[1] may transmit the action frame. The PHY circuit phy[0] (FIG. 2 with n=0) of the AP device sta[0] may receive the action frame from the requester device sta[1], and the AP device sta[0] may start the flowchart 300 in response.

The action frame which contains the request to enable the latency improvement may be an association action frame, a reassociation action frame or an operation-change action frame, etc., specified in the legacy Wi-Fi. According to the legacy Wi-Fi, when the device sta[1] is not yet a member of the service set 104 and desires to be associated with the AP device sta[0] to join the service set 104 as a member, the device sta[1] may transmit the association action frame to the AP device sta[0]; when the device sta[1] is associated with another access point of the service set 104 (not shown) and desires to be associated the AP device sta[0] for a change, the device sta[1] may transmit the reassociation action frame to the AP device sta[0]; and, when the device sta[1] is associated with the AP device sta[0] and desires to change operation, the device sta[1] may transmit the operation-change action frame to the AP device sta[0].

Step 304 (FIG. 3): in response to the request of enabling the latency improvement sent by the requester device sta[1], the AP device sta[0] may decide whether to enable the latency improvement of the invention. For example, in an embodiment, if the AP device sta[0] itself and the other devices sta[1] to sta[N] support the latency improvement, the flowchart 300 may proceed to step 306, and may otherwise proceed to step 312.

Step 306: the AP device sta[0] may configure a duration threshold T0 according to a latency requirement, and may then proceed to step 308. In an embodiment, the AP device sta[0] may obtain the latency requirement by handshaking with one or more other devices of the wireless network 100, such as the requester device sta[1]. For example, in an embodiment, when the MAC circuit mac[1] of the requester device sta[1] embeds the request to enable the latency improvement in the action frame at step 302, the MAC circuit mac[1] of the device sta[1] may also embed the latency requirement in the same action frame; thus, at step 306, the AP device sta[0] may configure the duration threshold T0 according to the latency requirement received from the requester device sta[1].

In an embodiment, the latency requirement may include a tolerable latency, and the AP device sta[0] may cause the duration threshold T0 not to be longer than the tolerable latency. In an embodiment, the tolerable latency may be shorter than the parameter aPPDUMaxTime specified in the legacy Wi-Fi. As some examples, the configured duration threshold T0 may be 0.2 ms, 0.5 ms, 0.75 ms, 1 ms, 1.25 ms, 1.5 ms, 1.75 ms, 2 ms, 4 ms or 5 ms, etc.

Step 308: when the AP device sta[0] has a transmission opportunity (TXOP, as specified in the legacy Wi-Fi), the PHY circuit phy[0] of the AP device sta[0] may transmit one or more PPDUs during the transmission opportunity, and the MAC circuit mac[0] of the AP device sta[0] may cause each of the one or more PPDUs not to be longer than the duration threshold T0 when the PHY circuit phy[0] of the device sta[0] transmits the one or more PPDUs, wherein each of the one or more PPDUs may be a downlink PPDU, and may comprise one or more MAC data frames which may contain user data, e.g., user data for downlink. A MAC data frame may be a MAC frame comprising a “type” subfield denoting the MAC frame itself is of a “data” type, rather than a “control” type or a “management” type.

In addition, according to the invention, the PHY circuit phy[1] of the requester device sta[1] may also transmit one or more PPDUs during the same transmission opportunity of the AP device sta[0], and the MAC circuit mac[1] of the requester device sta[1] may cause each of the one or more PPDU not to be longer than the duration threshold T0 when the PHY circuit phy[0] transmits the one or more PPDUs, wherein each of the one or more PPDUs may be an uplink PPDU, and may comprise one or more MAC data frames which may contain user data, e.g., user data for uplink.

In an embodiment, besides the AP device sta[0] and the requester device sta[1], other member(s) of the service set 104, e.g., one or more of the non-AP devices sta[2] to sta[N] of the wireless network 100, may also transmit PPDU(s) during the same transmission opportunity of the AP device sta[0], and may cause each PPDU not to be longer than the duration threshold T0 when transmitting each PPDU, wherein each PPDU may be an uplink PPDU, and may comprise one or more MAC data frames which may contain user data, e.g., user data for uplink.

In an embodiment, as one or more non-AP devices may also transmit PPDU(s) during the transmission opportunity of the AP device sta[0] and may constrain a duration of each PPDU according to the duration threshold T0 when transmitting the PPDU(s) at step 308, each of the one or more non-AP devices may configure its own duration threshold T0 earlier at step 306 by handshaking with other device(s), such as the AP device sta[0]. For example, in an embodiment, after the AP device sta[0] configures the duration threshold T0 at step 306, the AP device sta[0] may inform one or more other devices, e.g., one or more of the non-AP devices sta[1] to sta[N], regarding configuration of the duration threshold T0, so each of the one or more other devices may also configure its own duration threshold T0 at step 306 according to the configuration informed by (received from) the AP device sta[0], and may cause each transmitted PPDU not to be longer than the configured duration threshold T0 at step 308.

In an embodiment, the AP device sta[0] may configure two duration thresholds T0 and T1 at step 306, respectively for downlink and uplink. Hence, at step 308, the AP device sta[0] may cause each downlink PPDU not to be longer than the downlink duration threshold T0 when transmitting the downlink PPDU(s) during the transmission opportunity, while the non-AP requester device sta[1], as well as the remaining non-AP devices sta[2] to sta[N], may cause each uplink PPDU not to be longer than the uplink duration threshold T1 when transmitting the uplink PPDU(s) during the same transmission opportunity. The duration thresholds T0 and T1 may be equal or different.

Step 310: the AP device sta[0] may decide whether the latency improvement should be kept enabled; if true, the AP device sta[0] may cause the flowchart 300 to stay at step 308; otherwise, the AP device sta[0] may divert the flowchart 300 to step 312. For example, in an embodiment, the AP device sta[0] may decide whether to keep the latency improvement enabled according to whether the requester device sta[1] still demands low latency. After step 308 starts, when the requester device sta[1] no longer demands low latency, the requester device sta[1] may inform the AP device sta[0], and the AP device sta[0] may decide to end the latency improvement at step 310.

Step 312: the flowchart 300 may end. After the flowchart 300 ends, the devices sta[0] to sta[N] of the wireless network 100 may operate as specified in the legacy Wi-Fi: each device sta[n] of the devices sta[0] to sta[N] may transmit a PPDU during a transmission opportunity, and may not restrict duration of the PPDU by the duration threshold T0 configured according to the latency requirement.

To demonstrate execution of step 308 (FIG. 3), FIG. 4 depicts, according to an embodiment of the invention, network interaction during a transmission opportunity (TXOP) 400 of the AP device sta[0]. The transmission opportunity 400 may start at a time point t1 and end at a time point td[P]. As specified in the legacy Wi-Fi, the transmission opportunity 400 may be long enough to accommodate a physical layer protocol data unit (PPDU) as long as 5.484 ms, and may therefore fail to satisfy demands of low latency. However, by applying the flowchart 300 with the latency improvement of the invention enabled, the transmission opportunity 400 may cover a series of short PPDUs, such as one or more PPDUs D[1] to D[K] and/or one or more PPDUs U[1] to U[P] (with each of the indices K and P being an integer greater than or equal to one); a duration of each short PPDU may be constrained (at step 308) according to latency requirement (e.g., according to the duration threshold T0 configured at step 306), and the invention may therefore satisfy demands of low latency.

As depicted in FIG. 4, by applying the flowchart 300 with the latency improvement enabled, the transmission opportunity 400 may comprise a plurality of short sections, such as one or more sections DL[1] to DL[K] and/or one or more sections UL[1] to UL[P]; each section DL[k] (for k=1 to K) may cover the PPDU D[k] and an optional follow-up frame d[k], and each section UL[p] (for p=1 to P) may cover an optional preceding frame TG[p], the PPDU U[p] and an optional follow-up frame u[p]. Each PPDU D[k] may comprise one or more MAC data frames (not depicted) which may contain user data for downlink, and each PPDU U[p] may comprise one or more MAC data frames which may contain user data for uplink.

In each section DL[k], the physical layer protocol data unit (PPDU) D[k] may be a downlink PPDU transmitted by the AP device sta[0] (FIG. 1) at step 308 (FIG. 3), and may hence not be longer than the duration threshold T0 configured at step 306 according to the latency requirement. In each section UL[p], the PPDU U[p] may be an uplink PPDU transmitted by one of the non-AP devices sta[1] to sta[N] at step 308, and may hence not be longer than the duration threshold T0.

As depicted in FIG. 4, when the transmission opportunity 400 starts at the time point t1, the AP device sta[0] (FIG. 1) may request to send by transmitting an RTS frame from the time point t1 to a later time point t2, as specified in the legacy Wi-Fi; a first network allocation vector (NAV) 402 specified in the legacy Wi-Fi may start at the time point t2, and may end at the time point td[P]. In response to the RTS frame, each of the non-AP devices sta[1] to sta[N] may clear to send by transmitting a CTS frame between two time points t3 and t4 after the time point t2, as specified in the legacy Wi-Fi; a second network allocation vector (NAV) 404 specified in the legacy Wi-Fi may start at the time point t4, and may end at the time point td[P]. The first NAV 402 and/or the second NAV 404 may protect the one or more PPDUs D[1] to D[K] and/or the one or more PPDUs U[1] to U[P] from collision resulting from any other wireless network device which only supports the legacy Wi-Fi and does not support the latency improvement of the invention.

In response to the CTS frame, the one or more sections DL[1] to DL[K] and/or the one or more sections UL[1] to UL[P] according to the invention may sequentially start one after another. Each section DL[k] (k=1 to K) may extend between two time points ta[k] and tb[k], and each section UL[p] (p=1 to P) may extend between two time points tc[p] and td[p]. The sections DL[1] to DL[K] and UL[1] to UL[P] may not overlap; each section DL[k] may start after (or when) a preceding section (DL[k−1] or one of UL[1] to UL[P]) ends, and each section UL[p] may start after (or when) a preceding section (UL[p−1] or one of DL[1] to DL[K]) ends.

For concise disclosure of the invention, illustration in FIG. 4 assumes that the section DL[1] starts first, the sections DL[1] to DL[K] and UL[1] to UL[P] sequentially start in an interlacing order (e.g., DL[1], UL[1], DL[2], UL[2], . . . ), and the section UL[P] starts last to end at the time point td[P]. However, the invention is not so limited; for example, the section UL[1] may start first, the section DL[K] may start last, and/or, the sections DL[1] to DL[K] and UL[1] to UL[P] may sequentially start in other regular order (e.g., DL[1] to DL[3], UL[1] and UL[2], DL[4] to DL[6], UL[3] and UL[4], . . . ) or irregular order (e.g., DL[1], UL[1], DL[2] to DL[4], UL[2] and UL[3], DL[5] and DL[6], UL[4], . . . ). The indices K and P may be equal or different.

In an embodiment, the one or more PPDUs D[1] to D[K] and/or the one or more PPDUs U[1] to U[P] accommodated in the transmission opportunity 400 may be transmitted via an existed link (not depicted); for example, the existed link may already exist before the flowchart 300 (FIG. 3) starts step 302, or before determining whether to enable the latency improvement at step 304. In another embodiment, the one or more PPDUs D[1] to D[K] and/or the one or more PPDUs U[1] to U[P] accommodated in the transmission opportunity 400 may be transmitted via a dedicated link (not depicted) formed specifically for the latency improvement; for example, the dedicated link may be initialized after the latency improvement is decided to be enabled at step 304, but before the one or more PPDUs D[1] to D[K] and/or the one or more PPDUs U[1] to U[P] are transmitted at step 308. The link, either an existed one or a dedicated one, may extend across one or more basic service sets, including the service set 104 (FIG. 1).

FIG. 5a depicts one of the one or more sections DL[1] to DL[K], such as DL[k] (for k being one of 1 to K), according to an embodiment of the invention. As shown in FIG. 5 (and FIG. 4), the section DL[k] may start and end respectively at the time points ta[k] and tb[k], and may cover the physical layer protocol data unit (PPDU) D[k] and one or more follow-up frames da[k,1] to da[k,J[k]] (with the index J[k] being an integer greater than or equal to one), wherein the one or more follow-up frames da[k,1] to da[k,J[k]] in FIG. 5a may be represented by the follow-up frame d[k] in FIG. 4, i.e., the follow-up frame d[k] in FIG. 4 may be anyone of the one or more follow-up frames da[k,1] to da[k,J[k]]. Two indices J[k1] and J[k2] of two different sections DL[k1] and DL[k2] (for k1 and k2 being different two of 1 to K) may be equal or different.

The PPDU D[k] may be transmitted by the AP device sta[0] at step 308 (FIG. 3), may start at the time point ta[k] and end at a later time point ta1[k], and may comprise a front portion PHY_D[k] and one or more succeeding portions Dv[k,1] to Dv[k,M[k]], wherein the index M[k] may be an integer greater than or equal to one. Two indices M[k1] and M[k2] (for k1 and k2 being different two of 1 to K) of two PPDUs D[k1] and D[k2] respectively in two different sections DL[k1] and DL[k2] may be equal or different.

In the PPDU D[k], the front portion PHY_D[k] may start at the time point ta[k], may end at a time point ta0[k] between the time points ta[k] and ta1[k], and may include physical layer preamble and physical layer header composed according to the legacy Wi-Fi. Each succeeding portion Dv[k,m] (for m=1 to M[k]) may start and end at the time points ta0[k] and ta1[k] respectively. In an embodiment, the one or more succeeding portions Dv[k,1] to Dv[k,M[k]] of the PPDU D[k] may be transmitted using one or more resource units RU[k,1] to RU[k,M[k]] respectively, wherein each resource unit RU[k,m] (for m=1 to M[k]) may comprise one or more tones (subcarriers) uniquely allocated for the succeeding portion Dv[k,m]; in an embodiment, each resource unit RU[k,m] may be a resource unit (RU) specified in the legacy Wi-Fi.

As shown in FIG. 5a, the one or more follow-up frames da[k,1] to da[k,J[k]] may be transmitted by a subset (one, some or all) of the non-AP devices sta[1] to sta[N] (FIG. 1), such as on or more devices sta[nd[k,1]] to sta[nd[k,J[k]]] (for each of nd[k,1] and nd[k,J[k]] being one of 1 to N). The indices M[k] and J[k] may be equal or different. As the PPDU D[k] may end at the time point ta1[k], each follow-up frame da[k,j] (for j=1 to J[k]) transmitted by the device sta[nd[k,j]] may start at a time point ta2[k] after the time point ta1[k], and may end at another time point ta3[k] between the time points ta2[k] and tb[k]. The time points ta1[k] and ta2[k] may be different by an interframe space ia1[k] specified in the legacy Wi-Fi, and the time points ta3[k] and tb[k] may be different by an interframe space ia2[k] specified in the legacy Wi-Fi.

The AP device sta[0] may transmit the PPDU D[k] at step 308 (FIG. 3). In an embodiment, when the AP device sta[0] causes the PPDU D[k] not to be longer than the duration threshold T0 at step 308, the device sta[0] may cause a duration Ta1[k] (i.e., the duration of the PPDU D[k]) between the time points ta[k] and ta1[k] not to be longer than the duration threshold T0.

In an embodiment, when causing the PPDU D[k] not to be longer than the duration threshold T0 at step 308, the device sta[0] may cause a reference duration Ta2[k] between the time points ta[k] and ta2[k] not to be longer than the duration threshold T0, wherein the reference duration Ta2[k] may be a sum of the duration Ta1[k] and the interframe space ia1[k].

In an embodiment, when causing the PPDU D[k] not to be longer than the duration threshold T0 at step 308, the device sta[0] may cause a reference duration Ta3[k] between the time points ta[k] and ta3[k] not to be longer than the duration threshold T0, wherein the reference duration Ta3[k] may be a sum of the duration Ta1[k], the interframe space ia1[k], and a duration Td[k] of the one or more follow-up frames da[k,1] to da[k,J[k]]. Though the device sta[0] may transmit the PPDU D[k] at step 308 before the one or more devices sta[nd[k,1]] to sta[nd[k,J[k]]] transmit the one or more follow-up frames da[k,1] to da[k,J[k]], the duration Td[k] of the one or more follow-up frames da[k,1] to da[k,J[k]] may be predictable, and the device sta[0] may therefore cap the reference duration Ta3[k] by the duration threshold T0 at step 308 by constraining the duration Ta1[k] of the PPDU D[k] according to an expected value of the duration Td[k].

In an embodiment, when causing the PPDU D[k] not to be longer than the duration threshold T0 at step 308, the device sta[0] may cause a reference duration Ta4[k] between the time points ta[k] and tb[k] not to be longer than the duration threshold T0, wherein the reference duration Ta4[k] may be a sum of the duration Ta1[k], the interframe space ia1[k], the duration Td[k] of the one or more follow-up frames da[k,1] to da[k,J[k]], and the interframe space ia2[k].

FIG. 5b depicts one of one or more sections DL[1] to DL[K], e.g., DL[k] (for k being one of 1 to K), according to an embodiment of the invention. Comparing to the section DL[k] in FIG. 5a, the one or more follow-up frames da[k,1] to da[k,J[k]] may no longer be utilized in FIG. 5b. As shown in FIG. 5b, the device sta[0] may transmit the PPDU D[k] at step 308 from the time points ta[k] to ta1[k], wherein the time point ta1[k] may be earlier than the time point tb[k] by the interframe space ia1[k]. In an embodiment, when causing the PPDU D[k] not to be longer than the duration threshold T0 at step 308 (FIG. 3), the AP device sta[0] may cause the duration Ta1[k] between the time points ta[k] and ta1[k] not to be longer than the duration threshold T0. In an embodiment, when causing the PPDU D[k] not to be longer than the duration threshold T0 at step 308, the AP device sta[0] may cause the reference duration Ta2[k], which may be the sum of the duration Ta1[k] and the interframe space ia1[k], not to be longer than the duration threshold T0.

The embodiments of the section DL[k] depicted in FIG. 5a and FIG. 5b may be adopted alone or together. For example, in a first embodiment, each of the one or more sections DL[1] to DL[K] accommodated in the transmission opportunity 400 (FIG. 4) may be embodied according to FIG. 5a; in a second embodiment, each of the one or more sections DL[1] to DL[K] accommodated in the transmission opportunity 400 may be embodied according to FIG. 5b; in a third embodiment, a first nonempty subset of the one or more sections DL[1] to DL[K] may be embodied according to FIG. 5a, and a second nonempty subset of the one or more sections DL[1] to DL[K] may be embodied according to FIG. 5b.

In the section DL[k] shown in FIG. 5a and FIG. 5b, the one or more succeeding portions Dv[k,1] to Dv[k, M[k]] of the physical layer protocol data unit (PPDU) D[k] may have versatile usages. Based on FIG. 5a, FIG. 6a to FIG. 6c depict example usages of the one or more succeeding portions Dv[k,1] to Dv[k,M[k]] according to various embodiments of the invention, respectively.

As shown in FIG. 6a, in an embodiment, a subset (one, some or all) of the one or more succeeding portions Dv[k,1] to Dv[k,M[k]], such as one or more succeeding portions Dv[k,m1] to Dv[k,m2] (for each of m1 and m2 being one of 1 to M[k]), may be utilized to embed user data to be sent to a subset (one, some or all) of the devices sta[1] to sta[N] (FIG. 1), such as one or more devices sta[n1] to sta[n2] (for each of n1 and n2 being one of 1 to N); in response, the one or more devices sta[n1] to sta[n2] may utilize a subset (one, some or all) of the follow-up frames da[k,1] to da[k,J[k]], such as one or more follow-up frames da[k,j1] to da[k,j2] (for each of j1 and j2 being one of 1 to J[k]), for acknowledgment (e.g., block acknowledgment) of data reception. For example, the AP device sta[0] may adopt two succeeding portions Dv[k,1] and Dv[k,2] of the PPDU D[k] to embed user data respectively designated for two devices sta[1] and sta[2] of the devices sta[1] to sta[N], and may transmit the PPDU D[k] between the time points ta[k] and ta1[k]; in response, the two devices sta[1] and the sta[2] may respectively transmit follow-up frames da[k,1] and da[k,2] during the time points ta2[k] and ta3[k] to acknowledge reception of the user data.

As shown in FIG. 6b, in an embodiment, a subset (one, some or all) of the one or more succeeding portions Dv[k,1] to Dv[k,M[k]], such as one or more succeeding portions Dv[k,m3] to Dv[k,m4] (for each of m3 and m4 being one of 1 to M[k]), may be further divided into two (or more) sequential segments. For example, the succeeding portion Dv[k,m3] may be divided to comprise two segments D1[k,m3] and D2[k,m3], wherein the segment D1[k,m3] may start at the time point ta0[k], and may end at a time point ta′[k] between the time points ta0[k] and ta1[k]; the segment D2[k,m3] may start and end at the time points ta′[k] and ta1[k], respectively. Similarly, the succeeding portion Dv[k,m4] may comprise two segments D1[k,m4] (between the time points ta0[k] and ta′[k]) and D2[k,m4] (between the time points ta′[k] and ta1[k]). Each of these segments may be utilized to embed user data to be sent to one of the devices sta[1] to sta[N] (FIG. 1). For example, the segments D1[k,m3] to D1[k,m4] and D2[k,m3] to D2[k,m4] may embed user data to be sent to a subset (some or all) of devices sta[1] to sta[N], such as a plurality of devices sta[n3] to sta[n4] (for n3 and n4 being different two of 1 to N); in response, the devices sta[n3] to sta[n4] may utilize a subset (some or all) of the follow-up frames da[k,1] to da[k,J[k]], such as a plurality of follow-up frames da[k,j3] to da[k,j4] (for j3 and j4 being different two of 1 to J[k]), for acknowledgment (e.g., block acknowledgment) of data reception.

As a less abstract example of FIG. 6b, the AP device sta[0] may adopt two succeeding portions Dv[k,3] and Dv[k,4] of the PPDU D[k], and therefore four segments D1[k,3], D2[k,3], D1[k,4] and D2[k,4], to embed user data respectively designated for four other devices sta[3] to sta[6] of the devices sta[1] to sta[N]. The AP device sta[0] may transmit the PPDU D[k] between the time points ta[k] and ta1[k]; in response, the devices sta[3] to sta[6] may respectively transmit four follow-up frames da[k, 3] to da[k, 6] during the time points ta2[k] and ta3[k] to acknowledge reception of the user data.

As shown in FIG. 6c, one or more resource units originally allocated for a subset of the one or more succeeding portions Dv[k,1] to Dv[k,M[k]], such as a resource unit RU[m5] originally allocated for a succeeding portion Dv[k,m5] (for m5 being one of 1 to M[k]) of the one or more succeeding portions Dv[k,1] to Dv[k,M[k]], may be rearranged to function as reserved channel(s). For example, in an embodiment, the resource unit RU[m5] and the duration Ta0[k] (between the time points ta0[k] and ta1[k]), originally allocated for the AP device sta[0] to transmit the succeeding portion Dv[k,m5] of the one or more succeeding portions Dv[k,1] to Dv[k,M[k]], may be reserved for one or more non-AP devices to acknowledge reception (e.g., in response to user data received from a preceding PPDU D[k−1], not depicted); i.e., the one or more non-AP devices may transmit frame(s) of block acknowledgement during the duration Ta0[k] using the resource unit RU[m5]. Under such acknowledgment arrangement, the one or more follow-up frames da[k,1] to da[k,J[k]] (FIG. 5a) after the PPDU D[k] in each section DL[k] may be cancelled, as shown in FIG. 5b.

In an embodiment of FIG. 6c, the resource unit RU[m5] and the duration Ta0[k] originally allocated for the AP device sta[0] to transmit the succeeding portion Dv[k,m5] may be reserved for peer-to-peer communication, e.g., for one or more of the non-AP devices sta[1] to sta[N] to transmit user data. As an example, one of the non-AP devices sta[1] to sta[N] may transmit one or more frames during the duration Ta0[k] using the resource unit RU[k,m5]. As another example, a first one and a second one of the non-AP devices sta[1] to sta[N] may sequentially transmit frame(s) respectively during a first segment and a second segment of the duration Ta0[k] using the resource unit RU[m5]. In an embodiment, the resource unit RU[m5] and the duration Ta0[k] may be reserved for random access.

In an embodiment, the AP device sta[0] may adopt the usages depicted in FIG. 6a to FIG. 6c in the same PPDU D[k]. For example, the AP device sta[0] may transmit the succeeding portion Dv[k,1] of the PPDU D[k] from the time points ta0[k] to ta1[k] using the resource unit RU[1], may sequentially transmit the segments D1[k,2] and D2[k,2] of the succeeding portion Dv[k,2], respectively from the time points ta0[k] to ta′[k] and from the time points ta′[k] to ta1[k], using the resource unit RU[2], and may cause one or more non-AP devices to transmit during the time points ta0[k] to ta1[k] using resource unit RU[3] originally allocated for the succeeding portion Dv[k,3] of the PPDU D[k].

FIG. 7a depicts one of the one or more sections UL[1] to UL[P] (FIG. 4), such as UL[p] (for p being one of 1 to P), according to an embodiment of the invention. As shown in FIG. 7a (and FIG. 4), the section UL[p] may start and end respectively at the time points tc[p] and td[p], and may cover the preceding frame TG[p], one or more PPDUs U0[p,1] to U0[p,Q[p]] (with the index Q[p] being an integer greater than or equal to one), and the follow-up frame u[p]. The one or more PPDUs U0[p,1] to U0[p,Q[p]] in FIG. 7a may be represented by the PPDU U[p] in FIG. 4, i.e., the PPDU U[p] in FIG. 4 may be anyone of the one or more PPDUs U0[p,1] to U0[p,Q[p]]. Two indices Q[p1] and Q[p2] of two different sections UL[p1] and UL[p2] (for p1 and p2 being different two of 1 to P) may be equal or different.

The preceding frame TG[p] may be a trigger frame transmitted by the AP device sta[0] for triggering one or more of the non-AP devices sta[1] to sta[N] to upload, may start at the time point tc[p], and may end at a later time point tg[p]. In response to the preceding frame TG[p], a subset (one, some or all) of the devices sta[1] to sta[N], such as one or more devices sta[nu[p,1]] to sta[nu[p,Q[p]]] (with each of nu[p,1] to nu[p,Q[p]] being one of 1 to N), may respectively transmit the one or more PPDUs U0[p,1] to U0[p,Q[p]] at step 308 (FIG. 3) from a time point tc0[p] to a later time point tc1[p], wherein the time point tc0[p] may be later than the time point tg[p] by an interframe space ib1[p]. Each PPDU U0[p,q] (for q being 1 to Q[p]) may comprise one or more MAC data frames (not depicted) which contain user data. In response to the one or more PPDUs U0[p,1] to U0[p,Q[p]], the AP device sta[0] may then transmit the follow-up frame u[p] from a time point tc2[p] to a later time point tc3[p], wherein the time point tc2[p] may be behind the time point tc1[p] by an interframe space ib2[p], and the time point tc3[p] may be earlier than the time point td[p] by another interframe space ib3[p]. In an embodiment, the follow-up frame u[p] may be a frame to acknowledge reception of the one or more PPDUs U0[p,1] to U0[p,Q[p]].

When each device sta[nu[p,q]] (for q being 1 to Q[p]) transmits the physical layer protocol data unit (PPDU) U0[p,q] at step 308, the device sta[nu[p,q]] may cause the PPDU U0[p,q] not to be longer than the duration threshold T0. In an embodiment, the AP device sta[0] may inform the device sta[nu[p,q]] about the duration threshold T0 before the device sta[nu[p,q]] transmits the PPDU U0[p,q]; for example, the AP device sta[0] may embed he duration threshold T0 in the preceding frame TG[p], so the device sta[nu[p,q]] may set the duration threshold T0 at step 306, and may constrain duration of the PPDU U0[p,q] by the duration threshold T0 when transmitting the PPDU U0[p,q] at step 308. In an embodiment, the one or more devices sta[nu[p,1]] to sta[nu[p,Q[p]]] may respectively use one or more distinct resource units to transmit the one or more PPDUs U0[p,1] to U0[p,Q[p]], respectively.

Referring to FIG. 7a, in an embodiment, when the device sta[nu[p,q]] causes the PPDU U0[p,q] not to be longer than the duration threshold T0 at step 308, the device sta[nu[p,q]] may cause a duration Tc1[p] of the PPDU U0[p,q] not to be longer than the duration threshold T0, wherein the duration Tc1[p] may start and end at the time points tc0[p,q] and tc1[p] respectively. In an embodiment, when causing the PPDU U0[p,q] not to be longer than the duration threshold T0 at step 308, the device sta[nu[p,q]] may cause a reference duration Tc2[p] not to be longer than the duration threshold T0, wherein the reference duration Tc2[p] may start and end at the time points tc0[p] and tc2[p] respectively, and may be a sum of the duration Tc1[p] and the interframe space ib2[p]. In an embodiment, when causing the PPDU U0[p,q] not to be longer than the duration threshold T0 at step 308, the device sta[nu[p,q]] may cause a reference duration Tc3[p] not to be longer than the duration threshold T0, wherein the reference duration Tc3[p] may start and end at the time points tc0[p] and tc3[p] respectively, and may be a sum of the duration Tc1[p], the interframe space ib2[p] and a duration Tu[p] of the follow-up frame u[p]. In an embodiment, when causing the PPDU U0[p,q] not to be longer than the duration threshold T0 at step 308, the device sta[nu[p,q]] may cause a reference duration Tc4[p] not to be longer than the duration threshold T0, wherein the reference duration Tc4[p] may start and end at the time points tc0[p] and td[p] respectively, and may be a sum of the duration Tc1[p], the interframe space ib2[p], the duration Tu[p] and the interframe space ib3[p].

Referring to FIG. 7a, in an embodiment, when causing the PPDU U0[p,q] not to be longer than the duration threshold T0 at step 308, the device sta[nu[p,q]] may cause a reference duration Tc5[p] not to be longer than the duration threshold T0, wherein the reference duration Tc5[p] may start and end at the time points tg[p] and tc1[p] respectively, and may be a sum of the interframe space ib1[p] and the duration Tc1[p]. In an embodiment, when causing the PPDU U0[p,q] not to be longer than the duration threshold T0 at step 308, the device sta[nu[p,q]] may cause a reference duration Tc6[p] not to be longer than the duration threshold T0, wherein the reference duration Tc6[p] may start and end at the time points tg[p] and tc2[p] respectively, and may be a sum of the interframe space ib1[p], the duration Tc1[p] and the interframe space ib2[p]. In an embodiment, when causing the PPDU U0[p,q] not to be longer than the duration threshold T0 at step 308, the device sta[nu[p,q]] may cause a reference duration Tc7[p] not to be longer than the duration threshold T0, wherein the reference duration Tc7[p] may start and end at the time points tg[p] and tc3[p] respectively, and may be a sum of the interframe space ib1[p], the duration Tc1[p], the interframe space ib2[p] and the duration Tu[p]. In an embodiment, when causing the PPDU U0[p,q] not to be longer than the duration threshold T0 at step 308, the device sta[nu[p,q]] may cause a reference duration Tc8[p] not to be longer than the duration threshold T0, wherein the reference duration Tc8[p] may start and end at the time points tg[p] and td[p] respectively, and may be a sum of the interframe space ib1[p], the duration Tc1[p], the interframe space ib2[p], the duration Tu[p] and the duration of the in interframe space ib3[p].

Referring to FIG. 7a, in an embodiment, when causing the PPDU U0[p,q] not to be longer than the duration threshold T0 at step 308, the device sta[nu[p,q]] may cause a reference duration Tc9[p] not to be longer than the duration threshold T0, wherein the reference duration Tc9[p] may start and end at the time points tc[p] and tc1[p] respectively, and may be a sum of a duration Ttg[p] of the preceding frame TG[p], the interframe space ib1[p] and the duration Tc1[p]. In an embodiment, when causing the PPDU U0[p,q] not to be longer than the duration threshold T0 at step 308, the device sta[nu[p,q]] may cause a reference duration Tc10[p] not to be longer than the duration threshold T0, wherein the reference duration Tc10[p] may start and end at the time points tc[p] and tc2[p] respectively, and may be a sum of the duration Ttg[p], the interframe space ib1[p], the duration Tc1[p] and the interframe space ib2[p]. In an embodiment, when causing the PPDU U0[p,q] not to be longer than the duration threshold T0 at step 308, the device sta[nu[p,q]] may cause a reference duration Tc11[p] not to be longer than the duration threshold T0, wherein the reference duration Tc11[p] may start and end at the time points tc[p] and tc3[p] respectively, and may be a sum of the duration Ttg[p], the interframe space ib1[p], the duration Tc1[p], the interframe space ib2[p] and the duration Tu[p]. In an embodiment, when causing the PPDU U0[p,q] not to be longer than the duration threshold T0 at step 308, the device sta[nu[p,q]] may cause a reference duration Tc12[p] not to be longer than the duration threshold T0, wherein the reference duration Tc12[p] may start and end at the time points tc[p] and td[p] respectively, and may be a sum of the duration Ttg[p], the interframe space ib1[p], the duration Tc1[p], the interframe space ib2[p], the duration Tu[p] and the interframe space ib3[p]. Briefly speaking, the aforementioned reference duration may start at one of the time points tc[p], tg[p] and tc0[p], and may end at one of the time points tc1[p], tc2[p], tc3[p] and td[p].

FIG. 7b depicts one of the one or more sections UL[1] to UL[P], such as UL[p] (for p being one of 1 to P), according to an embodiment of the invention. Comparing to the section UL[p] in FIG. 7a, the preceding frame TG[p] in FIG. 7a may no longer be utilized in FIG. 7b. As shown in FIG. 7b, the one or more devices sta[nu[p,1]] to sta[nu[p,Q[p]]] may transmit the one or more PPDUs U0[p,1] to U0[p,Q[p]] at step 308 from the time point tc[p] to the time point tc1[p], and the device sta[0] may transmit the follow-up frame u[p] from the time point tc2[p] to the time point tc3[p].

Referring to FIG. 7b, in an embodiment, when the device sta[nu[p,q]] (for q being one of 1 to Q[p]) causes the PPDU U0[p,q] not to be longer than the duration threshold T0 at step 308, the device sta[nu[p,q]] may cause the duration Tc1[p] of the PPDU U0[p,q] not to be longer than the duration threshold T0, wherein the duration Tc1[p] may start and end at the time points tc[p] and tc1[p] respectively. In an embodiment, when causing the PPDU U0[p,q] not to be longer than the duration threshold T0 at step 308, the device sta[nu[p,q]] may cause the reference duration Tc2[p] not to be longer than the duration threshold T0, wherein the reference duration Tc2[p] may start and end at the time points tc[p] and tc2[p] respectively, and may be the sum of the duration Tc1[p] and the interframe space ib2[p]. In an embodiment, when causing the PPDU U0[p,q] not to be longer than the duration threshold T0 at step 308, the device sta[nu[p,q]] may cause the reference duration Tc3[p] not to be longer than the duration threshold T0, wherein the reference duration Tc3[p] may start and end at the time points tc[p] and tc3[p] respectively, and may be the sum of the duration Tc1[p], the interframe space ib2[p] and the duration Tu[p] of the follow-up frame u[p]. In an embodiment, when causing the PPDU U0[p,q] not to be longer than the duration threshold T0 at step 308, the device sta[nu[p,q]] may cause the reference duration Tc4[p] not to be longer than the duration threshold T0, wherein the reference duration Tc4[p] may start and end at the time points tc[p] and td[p] respectively, and may be the sum of the duration Tc1[p], the interframe space ib2[p], the duration Tu[p] and the interframe space ib3[p].

FIG. 7c depicts one of the one or more sections UL[1] to UL[P], such as UL[p] (for p being one of 1 to P), according to an embodiment of the invention. Comparing to the section UL[p] in FIG. 7a, the follow-up frame u[p] in FIG. 7a may no longer be utilized in FIG. 7c. As shown in FIG. 7c, the device sta[0] may transmit the preceding frame TG[p] from the time point tc[p] to the time points tg[p], and the one or more devices sta[nu[p,1]] to sta[nu[p,Q[p]]] may transmit the one or more PPDUs U0[p,1] to U0[p,Q[p]] at step 308 from the time point tc0[p] to the time point tc1[p], wherein the time point tc1[p] may be earlier than the time point td[p] by the interframe space ib2[p].

Referring to FIG. 7c, in an embodiment, when the device sta[nu[p,q]] (for q being one of 1 to Q[p]) causes the PPDU U0[p,q] not to be longer than the duration threshold T0 at step 308, the device sta[nu[p,q]] may cause the duration Tc1[p] of the PPDU U0[p,q] not to be longer than the duration threshold T0, wherein the duration Tc1[p] may start and end at the time points tc0[p] and tc1[p] respectively. In an embodiment, when causing the PPDU U0[p,q] not to be longer than the duration threshold T0 at step 308, the device sta[nu[p,q]] may cause the reference duration Tc2[p] not to be longer than the duration threshold T0, wherein the reference duration Tc2[p] may start and end at the time points tc0[p] and tc2[p] respectively, and may be the sum of the duration Tc1[p] and the interframe space ib2[p]. In an embodiment, when causing the PPDU U0[p,q] not to be longer than the duration threshold T0 at step 308, the device sta[nu[p,q]] may cause the reference duration Tc5[p] not to be longer than the duration threshold T0, wherein the reference duration Tc5[p] may start and end at the time points tg[p] and tc1[p] respectively, and may be the sum of the interframe space ib1[p] and the duration Tc1[p]. In an embodiment, when causing the PPDU U0[p,q] not to be longer than the duration threshold T0 at step 308, the device sta[nu[p,q]] may cause the reference duration Tc6[p] not to be longer than the duration threshold T0, wherein the reference duration Tc6[p] may start and end at the time points tg[p] and td[p] respectively, and may be the sum of the interframe space ib1[p], the duration Tc1[p] and the interframe space ib2[p]. In an embodiment, when causing the PPDU U0[p,q] not to be longer than the duration threshold T0 at step 308, the device sta[nu[p,q]] may cause the reference duration Tc9[p] not to be longer than the duration threshold T0, wherein the reference duration Tc9[p] may start and end at the time points tc[p] and tc1[p] respectively, and may be the sum of the duration Ttg[p] of the preceding frame TG[p], the interframe space ib1[p] and the duration Tc1[p]. In an embodiment, when causing the PPDU U0[p,q] not to be longer than the duration threshold T0 at step 308, the device sta[nu[p,q]] may cause the reference duration Tc10[p] not to be longer than the duration threshold T0, wherein the reference duration Tc10[p] may start and end at the time points tc[p] and td[p] respectively, and may be the sum of the duration Ttg[p], the interframe space ib1[p], the duration Tc1[p] and the interframe space ib2[p].

FIG. 7d depicts one of the one or more sections UL[1] to UL[P], such as UL[p] (for p being one of 1 to P), according to an embodiment of the invention. Comparing to the section UL[p] in FIG. 7a, the preceding frame TG[p] and the follow-up frame u[p] in FIG. 7a may no longer be utilized in FIG. 7d. As shown in FIG. 7d, the one or more devices sta[nu[p,1]] to sta[nu[p,Q[p]]] may transmit the one or more PPDUs U0[p,1] to U0[p,Q[p]] at step 308 from the time point tc[p] to the time point tc1[p].

Referring to FIG. 7d, in an embodiment, when the device sta[nu[p,q]] (for q being one of 1 to Q[p]) causes the PPDU U0[p,q] not to be longer than the duration threshold T0 at step 308, the device sta[nu[p,q]] may cause the duration Tc1[p] of the PPDU U0[p,q] not to be longer than the duration threshold T0, wherein the duration Tc1[p] may start and end at the time points tc[p] and tc1[p] respectively. In an embodiment, when causing the PPDU U0[p,q] not to be longer than the duration threshold T0 at step 308, the device sta[nu[p,q]] may cause the reference duration Tc2[p] not to be longer than the duration threshold T0, wherein the reference duration Tc2[p] may start and end at the time points tc[p] and td[p] respectively, and may be the sum of the duration Tc1[p] and the interframe space ib2[p].

Based on FIG. 7a, FIG. 8 depicts one of the one or more sections UL[1] to UL[P] (FIG. 4), such as UL[p] (for p being one of 1 to P), according to an embodiment of the invention. As shown in FIG. 8 (and FIG. 4), the section UL[p] may extend between the time points tc[p] and td[p], and may cover the preceding frame TG[p], one or more PPDUs U1[p,1] to U1[p,W[p]] and one or more PPDUs U2[p,1] to U2[p,W[p]] (with the index W[p] being an integer greater than or equal to one), as well as the follow-up frame u[p]. The one or more PPDUs U1[p,1] to U1[p,W[p]] and the one or more PPDUs U2[p,1] to U2[p,W[p]] in FIG. 8 may be represented by the PPDU U[p] in FIG. 4, i.e., the PPDU U[p] in FIG. 4 may be anyone of the one or more PPDUs U1[p,1] to U1[p,W[p]] and the one or more PPDUs U2[p,1] to U2[p,W[p]]. Two indices W[p1] and W[p2] of two different sections UL[p1] and UL[p2] (for p1 and p2 being different two of 1 to P) may be equal or different.

In FIG. 8, the preceding frame TG[p] may be a trigger frame transmitted by the AP device sta[0] for triggering one or more of the non-AP devices sta[1] to sta[N] (FIG. 1) to upload, may start at the time point tc[p], and may end at the later time point tg[p]. In response to the preceding frame TG[p], a first subset (one, some or all) of the devices sta[1] to sta[N], such as one or more devices sta[nu1[p,1]] to sta[nu1[p,W[p]]] (with each of nu1[p,1] to nu1[p,W[p]] being one of 1 to N), may respectively transmit the one or more PPDUs U1[p,1] to U1[p,W[p]] at step 308 (FIG. 3) from the time point tc0[p] to a later time point ti1[p]. Furthermore, in response to the preceding frame TG[p], a second subset (one, some or all) of the devices sta[1] to sta[N], such as one or more devices sta[nu2[p,1]] to sta[nu2[p,W[p]]] (with each of nu2[p,1] to nu2[p,W[p]] being one of 1 to N), may respectively transmit the one or more PPDUs U2[p,1] to U2[p,W[p]] at step 308 from a time point ti2[p] to the later time point tc1[p]. Each PPDU U1[p,w] (for w being 1 to W[p]) may comprise one or more MAC data frames (not depicted) which contain user data, and each PPDU U2[p,w] may comprise one or more MAC data frames (not depicted) which contain user data. In an embodiment, the time point ti1[p] may be earlier than the time point ti2[p] by a nonzero interframe space ic1[p]; in a different embodiment, the time point ti2[p] may coincide with the time point ti1[p], and the interframe space ic1[p] may reduce to zero. After the time point tc1[p], the AP device sta[0] may then transmit the follow-up frame u[p], e.g., a frame for block acknowledgment of data reception, from the time point tc2[p] to the time point tc3[p].

In an embodiment, the PPDUs U1[p,w] and U2[p,w] (for w=1 to W[p]) may be transmitted using a same resource unit RU[w]; on the other hand, two PPDUs U1[p,w1] and U1[p,w2] (with w1 and w2 being different two of 1 to W[p]) may be transmitted using two different resource units RU[w1] and RU[w2]; similarly, two PPDUs U2[p,w1] and U2[p,w2] (with w1 and w2 being different two of 1 to W[p]) may be transmitted using two different resource units.

When each device sta[nu1[p,w]] (for w being 1 to W[p]) transmits the PPDU U1[p,w] at step 308 (FIG. 3), the device sta[nu1[p,w]] may cause the PPDU U1[p,w] not to be longer than the duration threshold T0. When each device sta[nu2[p,w]] (for w being 1 to W[p]) transmits the PPDU U2[p,w] at step 308, the device sta[nu2[p,w]] may cause the PPDU U2[p,w] not to be longer than the duration threshold T0.

Referring to FIG. 8, in an embodiment, when the device sta[nu1[p,w]] causes the PPDU U1[p,w] not to be longer than the duration threshold T0 at step 308, the device sta[nu1[p,w]] may cause a duration Tu1[p] of the PPDU U1[p,w] not to be longer than the duration threshold T0. In an embodiment, when the device sta[nu1[p,w]] causes the PPDU U1[p,w] not to be longer than the duration threshold T0 at step 308, the device sta[nu1[p,w]] may cause a first reference duration (not depicted) not to be longer than the duration threshold T0, wherein the first reference duration may start at one of the time points tc[p], tg[p] and tc0[p], and may end at one of the time points ti1[p], ti2[p], tc1[p], tc2[p], tc3[p] and td[p]. For example, in an embodiment, the first reference duration may be a duration Ts1[p] which may start and end at the time points tc0[p] and ti2[p] respectively, and may be a sum of the duration Tu1[p] and the interframe space ic1[p].

Referring to FIG. 8, in an embodiment, when the device sta[nu2[p,w]] causes the PPDU U2[p,w] not to be longer than the duration threshold T0 at step 308, the device sta[nu2[p,w]] may cause a duration Tu2[p] of the PPDU U2[p,w] not to be longer than the duration threshold T0. In an embodiment, when the device sta[nu2[p,w]] causes the PPDU U2[p,w] not to be longer than the duration threshold T0 at step 308, the device sta[nu2[p,w]] may cause a second reference duration (not depicted) not to be longer than the duration threshold T0, wherein the second reference duration may start at one of the time points tc[p], tg[p], tc0[p], ti1[p] and ti2[p], and may end at one of the time points tc1[p], tc2[p], tc3[p] and td[p]. For example, in an embodiment, the second reference duration may be a duration Ts2[p] which may start and end at the time points tc0[p] and ti2[p] respectively, and may be a sum of the duration Tu2[p] and the interframe space ib2[p].

Because the preceding frame TG[p] and/or the follow-up frame u[p] in FIG. 7a may be optional, and may be cancelled if not utilized, the embodiments of the section UL[p] shown in FIG. 7b, FIG. 7c and FIG. 7d may be derived from the embodiment of the section UL[p] shown in FIG. 7a. Similarly, the preceding frame TG[p] and/or the follow-up frame u[p] in FIG. 8 may also be optional, and may be cancelled if not utilized; therefore, other embodiment(s) of the section UL[p], though not depicted, may be derived from the embodiment of the section UL[p] shown in FIG. 8.

The embodiments of the section UL[p] depicted in FIG. 7a to FIG. 7d and FIG. 8 may be adopted alone or together. For example, in a first embodiment, each of the one or more sections UL[1] to UL[P] accommodated in the transmission opportunity 400 (FIG. 4) may be embodied according to FIG. 7a; in a second embodiment, each of the one or more sections UL[1] to UL[P] accommodated in the transmission opportunity 400 may be embodied according to FIG. 7b; in a third embodiment, each of the one or more sections UL[1] to UL[P] accommodated in the transmission opportunity 400 may be embodied according to FIG. 7c; in a fourth embodiment, each of the one or more sections UL[1] to UL[P] accommodated in the transmission opportunity 400 may be embodied according to FIG. 7d; in a fifth embodiment, a first nonempty subset of the one or more sections UL[1] to UL[P] may be embodied according to a first one of FIGS. 7a to 7d and 8, and a second nonempty subset of the one or more sections UL[1] to UL[P] may be embodied according to a second one of FIGS. 7a to 7d and 8, etc. In an embodiment, the PPDU arrangement in FIGS. 7a to 7d and the PPDU arrangement in FIG. 8 may be combined in the same section UL[p]; for example, the device sta[1] may transmit the PPDU U0[p,1] from the time points tc0[p] to tc1[p] using the resource unit RU[1] as depicted in FIG. 7a, while the device sta[2] may transmit the PPDU U1[p,2] from the time points tc0[p] to ti1[p] using the resource unit RU[2], and then the device sta[3] may transmit the PPDU U2[p,2] from the time points ti2[p] to tc1[p] also using the resource unit RU[2], as depicted in FIG. 8.

To sum up, a transmission opportunity, which is originally arranged for transmitting a single long PPDU according to the legacy Wi-Fi and is therefore unsatisfactory for demands of low latency, may be rearranged according to the invention to accommodate a series of short PPDUs, with a duration of each short PPDU being constrained according to a latency requirement. The short PPDUs accommodated in the transmission opportunity may be respectively transmitted by different devices (stations) of a wireless network, each short PPDU may comprise MAC data frame(s) containing user data, and hence user data may be exchanged across the different devices. Since the duration of each short PPDU is controlled according to the latency requirement, the invention may effectively satisfy demands of low latency.

Briefly speaking, in an embodiment of the invention, the AP device sta[0] (FIG. 1) may coordinate with other non-AP devices sta[1] to sta[N] for determining whether to start the flowchart 300 (FIG. 3), whether to enable the latency improvement of the invention at step 304, and how to configure the duration threshold T0 at step 306 if the latency improvement is enabled. If the latency improvement is enable, the AP device sta[0] and the non-AP devices sta[1] to sta[N] may be allowed to transmit PPDUs of user data respectively during a same transmission opportunity, wherein the MAC circuit mac[n] (FIG. 2) of each device sta[n] (for n=0 to N) may cause its own PPDU not to be longer than the duration threshold T0 when the PHY circuit phy[n] transmits the PPDU.

When the latency improvement is enabled and the MAC circuit mac[n] of each device sta[n] (for n=0 to N) causes a PPDU not to be longer than the duration threshold T0, the MAC circuit mac[n] may cause a reference duration related to the PPDU not to be longer than the duration threshold T0, wherein the reference duration may be a duration between a first reference time point and a second reference time point. In an embodiment (e.g., FIG. 5a or 5b) of the invention, for the MAC circuit mac[0] of the AP device sta[0], the first reference time point may be a time point (e.g., ta[k] in FIG. 5a or 5b) when the PPDU starts, and the second reference time point may be a time point (e.g., ta1[k] in FIG. 5a or 5b) when the PPDU ends, a time point (e.g., ta2[k] or tb[k] in FIG. 5a or 5b) when a first interframe space (e.g., ia1[k] in FIG. 5a or 5b) elapses after the PPDU ends, a time point (e.g., ta3[k] in FIG. 5a) when a follow-up frame (e.g., d[k] in FIG. 5a), which may be transmitted after the first interframe space elapses, ends, or a time point (e.g., tb[k] in FIG. 5a) when a second interframe space (e.g., ia2[k] in FIG. 5a) elapses after the follow-up frame ends.

In an embodiment (e.g., FIG. 7a to FIG. 7d) of the invention, for the MAC circuit mac[n] of each non-AP device sta[n] (for n=1 to N), the first reference time point may be a time point (e.g., tc[p] in FIG. 7a or 7c) when a preceding frame (e.g., TG[p] in FIG. 7a or 7c), which may be transmitted before the PPDU, starts, a time point (e.g., tg[p] in FIG. 7a or 7c) when the preceding frame ends, a time point (e.g., tc0 in FIG. 7a or 7c) when a first interframe space (e.g., ib1[p] in FIG. 7a or 7c) elapses after the preceding frame ends, or a time point (e.g., tc[p] in FIG. 7b or 7d) when the PPDU starts. The second reference time point may be a time point (e.g., tc1[p] in FIG. 7a, 7b, 7c or 7d) when the PPDU ends, a time point (e.g., tc2[p] in FIG. 7a or 7b, or td[p] in FIG. 7c or 7d) when a second interframe space (e.g., ib1[p] in FIG. 7a, 7b, 7c or 7d) elapses after the PPDU ends, a time point (e.g., tc3[p] in FIG. 7a or 7b) when a follow-up frame (e.g., u[p] in FIG. 7a or 7b), which may be transmitted after the second interframe space elapses, ends, or a time point (e.g., td[p] in FIG. 7a or 7b) when a third interframe space (e.g., ib3[p] in FIG. 7a or 7b) elapses after the follow-up frame ends.

If the latency improvement is not enabled, the devices sta[0] to sta[N] may transmit PPDUs of user data according to the legacy Wi-Fi; e.g., the AP device sta[0] may transmit a PPDU during one downlink transmission opportunity, a subset of the non-AP devices sta[1] to sta[N] may transmit concurrent PPDU(s) during another one uplink transmission opportunity, and the MAC circuit mac[n] of each device sta[n] (for n=0 to N) may not restrict duration of the PPDU by the duration threshold T0.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for improving latency of a wireless network; the method being executed by a device of the wireless network, and the method comprising:
configuring a duration threshold according to a latency requirement; and
when transmitting a physical layer protocol data unit (PPDU) over the wireless network, causing the PPDU not to be longer than the duration threshold.

2. The method of claim 1, wherein the latency requirement is obtained by handshaking with one or more other devices of the wireless network.

3. The method of claim 1, wherein the latency requirement is received from one or more other devices of the wireless network.

4. The method of claim 1, wherein:
the latency requirement includes a tolerable latency; and
when configuring the duration threshold according to the latency requirement, causing the duration threshold not to be longer than the tolerable latency.

5. The method of claim 4, wherein:
the tolerable latency is shorter than a parameter aPPDUMaxTime specified in IEEE 802.11, with IEEE being an abbreviation of institute of electrical and electronics engineers.

6. The method of claim 1, wherein the device is a Wi-Fi access point (AP) or hot spot.

7. The method of claim 1, wherein:
the PPDU is followed by a follow-up frame transmitted after an interframe space elapses;
when causing the PPDU not to be longer than the duration threshold, causing a reference duration not to be longer than the duration threshold; and
the reference duration is a sum of a duration of the PPDU, the interframe space and a duration of the follow-up frame.

8. The method of claim 1, wherein:
when transmitting the PPDU, transmitting the PPDU using a first resource unit, and causing another device of the wireless network to transmit using a second resource unit during the PPDU.

9. The method of claim 1, wherein:
transmitting the PPDU is executed during a transmission opportunity; and
the method further comprises:
after transmitting the PPDU, causing another device of the wireless network to transmit a second PPDU during the transmission opportunity, and causing said another device to cause the second PPDU not to be longer than the duration threshold when said another device transmits the second PPDU.

10. The method of claim 1, wherein the device is a non-AP station.

11. The method of claim 1, wherein:
transmitting the PPDU is executed after a preceding frame is transmitted and an interframe space elapses; and
when causing the PPDU not to be longer than the duration threshold, causing a reference duration not to be longer than the duration threshold; and
the reference duration is a sum of a duration of the preceding frame, the interframe space and a duration of the PPDU.

12. The method of claim 1, wherein:
transmitting the PPDU is executed after a preceding frame is transmitted and a first interframe space elapses; and
the PPDU is followed by a follow-up frame transmitted after a second interframe space elapses;
when causing the PPDU not to be longer than the duration threshold, causing a reference duration not to be longer than the duration threshold; and
the reference duration is a sum of a duration of the preceding frame, the first interframe space, a duration of the PPDU, the second interframe space and a duration of the follow-up frame.

13. The method of claim 1 further comprising:
determining whether to enable a latency improvement before causing the PPDU not to be longer than the duration threshold; wherein:
causing the PPDU not to be longer than the duration threshold is executed if the latency improvement is enabled.

14. The method of claim 13 further comprising:
not restricting a duration of the PPDU according to the duration threshold if the latency improvement is not enabled.

15. The method of claim 13, wherein:
when transmitting the PPDU, transmitting the PPDU via a dedicated link which is initialized after determining to enable the latency improvement.

16. The method of claim 13, wherein:
when transmitting the PPDU, transmitting the PPDU via an existed link which exists before determining whether to enable the latency improvement.

17. A network circuit for a device of a wireless network; the network circuit comprising:
a physical layer (PHY) circuit arranged to transmit a physical layer protocol data unit (PPDU) over the wireless network; and
a medium access control (MAC) circuit coupled to the PHY circuit, and arranged to:
cause the PPDU not to be longer than a duration threshold if a latency improvement is enabled; and
not restrict a duration of the PPDU by the duration threshold if the latency improvement is not enabled.

18. The network circuit of claim 17, wherein the duration threshold is configured according to a latency requirement received from another device of the wireless network.

19. The network circuit of claim 17, wherein:
the PPDU is followed by a follow-up frame transmitted after an interframe space elapses;
the MAC circuit is arranged to:
when causing the PPDU not to be longer than the duration threshold, cause a reference duration, which is a sum of a duration of the PPDU, the interframe space and a duration of the follow-up frame, not to be longer than the duration threshold.

20. The network circuit of claim 17, wherein:
the PHY circuit is further arranged to transmit the PPDU after the PHY circuit receives a preceding frame and an interframe space elapses; and
the MAC circuit is arranged to:
when causing the PPDU not to be longer than the duration threshold, cause a reference duration, which is a sum of a duration of the preceding frame, the interframe space and a duration of the PPDU, not to be longer than the duration threshold.
